(19) United States
(12) Patent Application Publication
(10) Pub. No.: US 2024/0063985 A1
(43) Pub. Date: Feb. 22, 2024

(54) DETERMINING BASEBAND PROCESSING CAPABILITY USING CHANNEL BANDWDITH MULTIPLIED BY LAYERS

(71) Applicant: T-MOBILE INNOVATIONS LLC, Overland Park, KS (US)

(72) Inventors: William Martin SHVODIAN, McLean, VA (US); David Charles JONES, Bellevue, WA (US)

(21) Appl. No.: 18/231,425

(22) Filed: Aug. 8, 2023

Related U.S. Application Data
(60) Provisional application No. 63/398,624, filed on Aug. 17, 2022.

(51) Int. Cl. H04L 5/00

(52) U.S. Cl. CPC H04L 5/0094

(57) ABSTRACT

A method, apparatus, system, and computer-readable storage media are provided. Carrier aggregation capability information can be received from a UE. The carrier aggregation capability information can comprise a maximum supported bandwidth multiplied by MIMO layers. The maximum supported layers bandwidth is then utilized in conjunction with one or more network resource parameters to configure carrier aggregation on the UE, with the total bandwidth of carrier aggregation multiplied by MIMO layers configured on the UE does not exceed the maximum supported layers bandwidth.

### CROSS-REFERENCE TO RELATED APPLICATIONS

This application claims the benefit of U.S. Provisional Application No. 63/398,624 entitled “Channel bandwidths times layers as an indication of baseband processing capacity,” filed Aug. 17, 2022, the entirety of which is incorporated by reference herein.

### BACKGROUND

The present disclosure is directed to channel bandwidths multiplied by layers as an indication of baseband processing capacity. Carrier aggregation improves data rates for user equipments (UEs) by increasing the overall bandwidth of the logical channels available to send data to and from the operator core. A UE's bandwidth processing limitations may hinder a determination of how much bandwidth the UE can achieve with carrier aggregation because multiple-input multiple-output (MIMO) layers are not factored into the calculation of the UE's maximum supported bandwidth.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

A UE may use carrier aggregation to improve data rates by increasing the bandwidth of logical channels for data transmission. In order to utilize carrier aggregation the UE transmits information indicating baseband processing capacity to an access point. A method, system, apparatus, and computer-readable media are provided. Embodiments described herein provide a method for utilizing channel bandwidth and communication layers to indicate baseband processing capacity. The method begins with receiving carrier aggregation capability information from a UE. The carrier aggregation capability information comprises a maximum supported layers bandwidth, which is based on the maximum supported bandwidth multiplied by a number of communication layers. The communication layers may be MIMO layers with which the UE can be configured. The maximum supported layers bandwidth is then used in conjunction with one or more network resource parameters to configure carrier aggregation on the UE, wherein a total bandwidth of carrier aggregation multiplied by layers configured on the UE does not exceed the maximum supported layers bandwidth.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment, in accordance with some embodiments described herein;

FIG. 2 depicts a cellular network suitable for use in implementations of the present disclosure, in accordance with aspects herein;

FIG. 3 depicts a first example of a carrier aggregation and MIMO configuration based on the reported UE baseband processing capacity of channel bandwidth multiplied by layer suitable for use in implementations of the present disclosure, in accordance with aspects herein;

FIG. 4 depicts a second example of a carrier aggregation and MIMO configuration based on the reported UE baseband processing capacity of channel bandwidth multiplied by layers suitable for use in implementations of the present disclosure, in accordance with aspects herein;

FIG. 5 depicts a third example of a carrier aggregation and MIMO configuration based on the reported UE baseband processing capacity of channel bandwidth multiplied by layers suitable for use in implementations of the present disclosure, in accordance with aspects herein;

FIG. 6 depicts a fourth example of a carrier aggregation and MIMO configuration based on the reported UE baseband processing capacity of channel bandwidth multiplied by layers suitable for use in implementations of the present disclosure, in accordance with aspects herein;

FIG. 7 depicts a fifth example of a carrier aggregation and MIMO configuration based on the reported UE baseband processing capacity of channel bandwidth multiplied by layers suitable for use in implementations of the present disclosure, in accordance with aspects herein;

FIG. 8, is a flow diagram of a method for utilizing channel bandwidth and communication layers to indicate baseband processing capacity; and

FIG. 9 is diagram illustrating an example computing environment according to an embodiment.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Wireless telecommunications networks, such as 5G and LTE networks are standardized to facilitate aggregation of multiple carrier combinations in order to provide higher data speeds and throughput to the user equipment (UE) of end users. Carrier Aggregation (CA) is a provision of 5G and LTE standards that enables wireless operators to combine distinct carrier channels from a primary serving cell (P-cell) and at least one secondary serving cell (S-cell) into a single data channel to obtain higher data rates with mobile user equipment (UE). In general, for a UE to benefit from carrier aggregation, the UE is located within an overlapped area of cell boundaries that includes coverage from a primary serving cell operating via a primary component carrier (e.g. at carrier frequency, f₁), and a secondary serving cell operating via a second component carrier (e.g. at carrier frequency, f₂). The primary component carrier and second component carrier can either be within the same frequency band (e.g., both carriers in band N41) or within different frequency bands (e.g., one carrier in band N41 and the other in band N71). It should also be understood that primary component carrier and second component carrier can both implement the same duplexing scheme (e.g., both frequency division duplexing (FDD) and time division duplexing (TDD)), or different duplexing schemes (e.g., a combination of FDD and TDD).

The use of carrier aggregation improves data rates for UE by increasing the overall bandwidth of the logical channel available to the UE to send and/or receive data to the network operator core.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Further, various technical terms are used throughout this description. An illustrative resource that fleshes out various aspects of these terms may be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of access points (i.e., access point, node, cell sites, cell towers) to provide network coverage. The access points are employed to broadcast and transmit transmissions to user devices of the telecommunications network. An access point may be considered to be a portion of an access point that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, an access point may comprise one access point or more than one access point. Factors that can affect the telecommunications transmission include, e.g., location and size of the access points, and frequency of the transmission, among other factors. The access points are employed to broadcast and transmit transmissions to user devices of the telecommunications network. Traditionally, the access point establishes uplink (or downlink) transmission with a mobile handset over a single frequency that is exclusive to that particular uplink connection (e.g., an LTE connection with an EnodeB). The access point may include one or more sectors served by individual transmitting/receiving components associated with the access point (e.g., antenna arrays controlled by an EnodeB). These transmitting/receiving components together form a multi-sector broadcast arc for communication with mobile handsets linked to the access point.

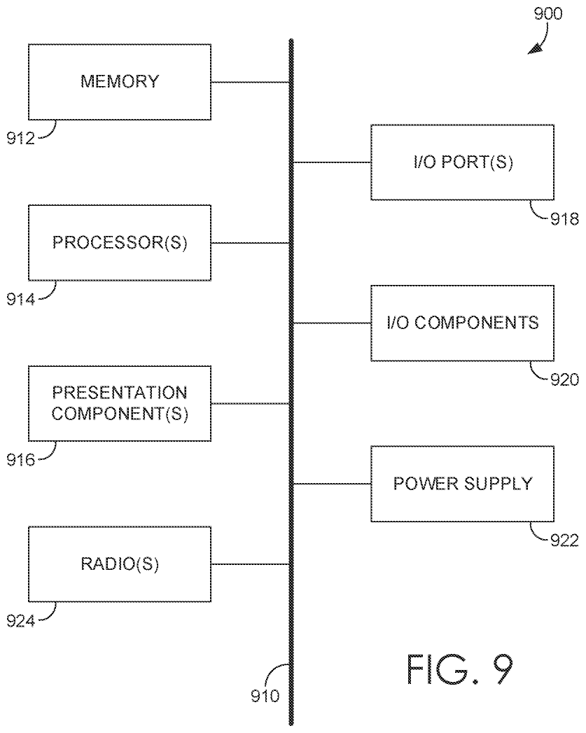

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point. A UE may be, in an embodiment, similar to computing device 900 described herein with respect to FIG. 9.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR), reference signal received quality (RSRQ), and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

A first aspect of the present disclosure provides a method for utilizing channel bandwidth and communication layers to indicate baseband processing capacity. The method begins with receiving carrier aggregation capability information from a UE. The carrier aggregation capability information comprises a maximum supported layers bandwidth, which is based on the maximum supported bandwidth multiplied by a number of communication layers. The communication layers may be MIMO layers with which the UE can be configured. The maximum supported layers bandwidth is then used in conjunction with one or more network resource parameters to configure carrier aggregation on the UE, wherein a total bandwidth of carrier aggregation multiplied by layers configured on the UE does not exceed the maximum supported layers bandwidth.

A second aspect of the present disclosure provides a method for utilizing channel bandwidth and communication layers to indicate baseband processing capacity. The method begins with the UE transmitting carrier aggregation capability information to an access point. The carrier aggregation capability information comprises a maximum supported layers aggregated bandwidth multiplied by layers. The UE then receives instructions to configure carrier aggregation and MIMO on the UE, wherein the total bandwidth of carrier aggregation multiplied by layers does not exceed the maximum supported layers bandwidth and is based on a maximum supported aggregated layers bandwidth reported as UE capabilities.

Another aspect of the present disclosure is directed to a non-transitory computer storage media storing computer-usable instructions that cause the processor to receive carrier aggregation capability information from a UE, wherein the carrier aggregation capability information comprises a maximum supported layers bandwidth, the maximum supported layers bandwidth based on the maximum supported bandwidth multiplied by a number of communication layers with which the UE can be configured. The processors then utilize the maximum supported layers bandwidth and one or more network resource parameters to configure carrier aggregation on the UE, wherein a total bandwidth of carrier aggregation multiplied by MIMO layers configured on the UE does not exceed the maximum supported layers bandwidth. s

One or more of the embodiments of the present disclosure provide for, among other things, determining a maximum supported bandwidth for a UE for carrier aggregation while considering a number of communication layers (e.g., MIMO layers). UEs may report their capabilities to the network and this reporting may be performed per band and may include information on supported bandwidths and the maximum bandwidth the UE can support. In addition UE capabilities may be reported for various types of carrier aggregation. One advantage of carrier aggregation is that it can utilize more bandwidth than it could without carrier aggregation, but because of a UE's bandwidth processing limitation, this may present difficulty as to determining how much bandwidth the UE can actually process when using carrier aggregation. UEs are generally able to report which band combinations the UE can support, whether that be two bands, three bands, four bands, etc. This may be intra-band or inter-band for carrier aggregation. The carrier aggregation types supported may include new radio carrier aggregation (NR-CA), new radio dual connectivity (NR-DC), and evolved universal terrestrial radio access new radio (EN-DC). NR-DC allows a single UE to connect to both a sub-6 GHz access point and a millimeter wave access point. NR-DC couples the broader reach of a mid-band with the faster speed of millimeter wave. EN-DC allows a UE to exchange data between the UE and a NR access point while maintaining a simultaneous connection with an LTE access point. For a band combination, a UE reports the bands used, the maximum bandwidth for each band in the combination, if less than the supported bandwidth for the band. A UE may also report multiple feature sets to indicate limitations related to the maximum processing capability of the UE.

While a UE may be able to support a certain combination of bands, there is a limit as to how much bandwidth the UE can support. Currently, there are maximum supported bandwidths that the network utilizes for each UE, but communication layers (e.g., MIMO layers) are not factored into the calculation of the maximum supported bandwidth. Even if the network were to compute a maximum bandwidth for each band used for carrier aggregation, this still does not consider the number of communication layers used to communicate between the UE and the network. For example, in a given band, there may be 100 MHz of spectrum, and the UE receiver could have 2 receive chains (e.g., layers) for 2×2 MIMO, or 4 receive chains for 4×4 MIMO, etc. In some instances, rules (e.g., rule table) have been used to determine a maximum bandwidth for a UE using carrier aggregation. If a rule was made regarding maximum bandwidth with more than one communication layer in a frequency range, too much bandwidth would be coming in.

While the amount of bandwidth that is used is relatively static, the number of MIMO layers for both uplink and downlink communications varies with channel conditions. The network configures the UE with how many MIMO layers are being used. The UE can send a capability report on carrier aggregation to the network that reports each of the bands it supports, and the bandwidth for each band, in addition to the carrier aggregation combinations that it supports using those bands. The UE, in this instance provides the network with its carrier aggregation capabilities, and the network configures the UE in a particular way based on its capabilities. The advantages in taking into account communication layers when determining a maximum supported bandwidth is that the UE will not be overburdened by configuring the UE with more layers or more bandwidth than it can support.

Along with the information in the capability report from the UE, the network may also take into account one or more network resource parameters, such as SINR, or other signal metrics, how busy the carrier is, which frequency bands are available, etc. The network can use the capability report information and the one or more network resource parameters to determine a maximum supported bandwidth that takes into account the number of communication layers. Generally, this is computed by multiplying the maximum supported bandwidth by the number of communication layers. In addition, the UE could report different capability information for NR-CA, EN-DC, NR-DC, and different frequency bands (e.g., FR1+FR2). The main purpose of taking into account communication layers is so the UE is configured to not exceed its capabilities.

In one example, the UE may communicate a capability report to the network indicating that it is capable of two band carrier aggregation. The network, now knowing that information, may assign the UE frequency band 1, having two layers, with 100 MHz being the maximum bandwidth. The network may look at its priority list and try to assign the UE one primary band (e.g., primary carrier, p-cell) to use, and also a secondary cell for adding capacity when needed. The primary band could provide, for instance, a higher frequency band that doesn't have full coverage. The secondary band (e.g., secondary carrier, s-cell) could, for instance, provide mid-band or millimeter wave spectrum and be used when the UE has a lot of traffic, either to or from the UE. If there isn't a lot of traffic with the UE on uplink or downlink, the network/UE may discontinue use of carrier aggregation and just use the primary band for communications. But, when the UE has a lot of traffic on the uplink or downlink and needs additional frequency resources, the network will enable carrier aggregation such that the secondary band will also be used. In addition to the maximum bandwidth multiplied by layers UE capability, the UE may also declare a maximum bandwidth for a particular combination. When a UE uses maximum bandwidth multiplied by layers the result is proportion to the UE's digital baseband capacity.

A UE may be configured with various bandwidths in each frequency band in the combination and the multiple layers, as long as the total aggregated bandwidth is less than the declared maximum aggregated bandwidth and the sum of the bandwidth multiplies by layers for each of the aggregated bands is less than or equal to the declared maximum bandwidth multiplied by layers capability. The maximum bandwidth multiplied by layers may be declared on a per-UE basis, or per band combination, as well as for different frequency ranges.

With the embodiments presented herein, the end user benefits from an enhanced user experience resulting from the greater data speeds and throughput achievable using carrier aggregation and MIMO. Moreover, technical benefits are realized with respect to network planning because network operators can plan for more optimal utilization of carrier aggregation and MIMO by UE within each primary serving cell.

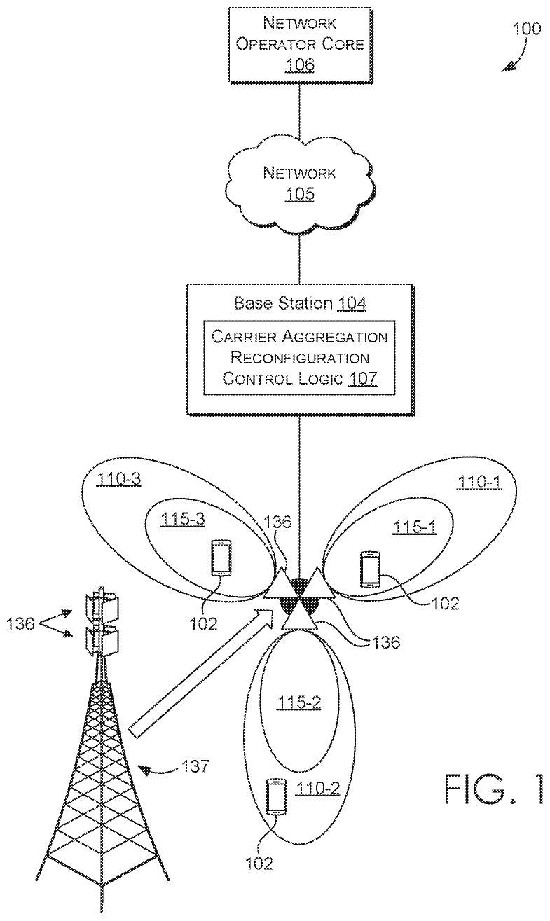

FIG. 1 is a diagram illustrating an example network environment 100 embodiment in which aspects of dynamic carrier aggregation configuration management. Network environment 100 is but one example of a suitable network environment and is not intended to suggest any limitation as to the scope of use or functionality of the embodiments disclosed herein. Neither should the network environment 100 be interpreted as having any dependency or requirement relating to any one or combination of components illustrated.

As shown in FIG. 1, network environment 100 comprises a network operator core 106 that provides one or more wireless network services to one or more UE 102 via a base station 104, often referred to as a radio access network (RAN). In the context of fourth generation (4G) Long Term Evolution (LTE), the base station 104 may be referred to as an eNodeB, eNB, or access point. In the context of fifth generation (5G) New Radio (NR), the base station 104 may be referred to as a gNodeB, or gNB. Other terminology may also be used depending on the specific implementation technology. In particular, each UE 102 communicates with the network operator core 106 via the base station 104 over one or both of uplink (UL) radio frequency (RF) signals and downlink (DL) RF signals. The base station 104 may be coupled to the network operator core 106 by a backhaul network 105 that comprises wired and/or wireless network connections that may include wireless relays and/or repeaters. In some embodiments, the base station 104 is coupled to the network operator core 106 at least in part by the Internet or other public network infrastructure. The network environment 100 is configured for wirelessly connecting UEs 102 to other UEs 102 via the same base station 104, via other base stations, or via other telecommunication networks such as network 105 or a publicly-switched telecommunication network (PSTN), for example. Generally, each UE 102 is a device capable of unidirectional or bidirectional communication with radio units (also often referred to as radio points or wireless access points) of the base station 104 using RF waves.

As illustrated in FIG. 1, the base station 104 radiates and receives RF signals via one or more directional antennas 136 that each serve UE 102 that are located within a geographic area referred to as a cell or sector. The specific size, shape and orientation of a cell is a function, at least in part, on the design and azimuth (tilt) of each of the several antennas 136, and the carrier frequency of the carrier serving that cell. In the particular embodiment illustrated in FIG. 1, base station 104 forms six cells (or sectors) each via a respective antenna 136 mounted to a site tower 137. In other embodiments, a few or greater number of cells may be formed.

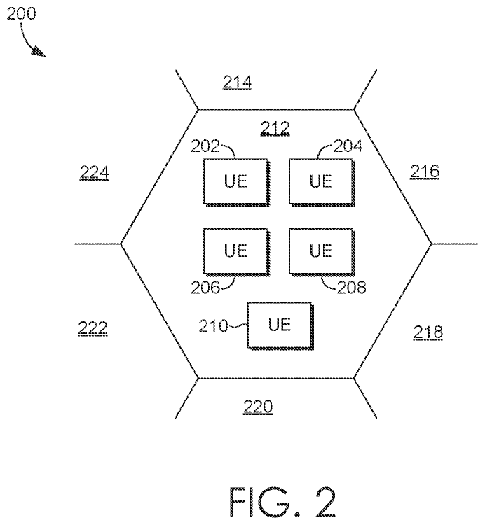

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including access point 114, backhaul channel 116, antenna 136 for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210 may be located within geographic area 200 collecting UE data that is useable by network component 130, in accordance with aspects herein. UEs 202, 204, 206, 208, and 210 can move within the cell currently occupied, such as cell site 212 and can move to other cells such as adjoining cell sites 214, 216, 218, 220, 222 and 224.

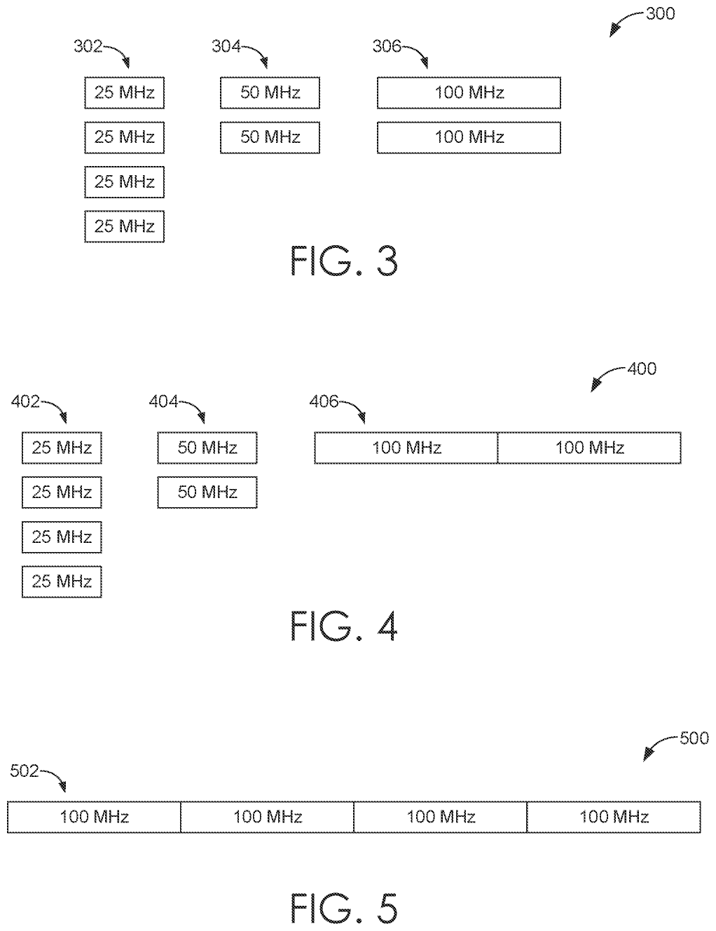

FIG. 3 depicts a first example of a carrier aggregation and MIMO configuration based on the reported UE baseband processing capacity of channel bandwidth multiplied by layers suitable for use in implementations of the present disclosure, in accordance with aspects herein. In the first baseband processing capacity configuration 300 the UE supports 400 MHz maximum layers multiplied by the bandwidth. The maximum bandwidth multiplied by layers is roughly proportional to the UE's digital baseband capacity. The UE may be configured with various bandwidths in each frequency band in the combination and various numbers of layers. The total aggregated bandwidth should be less than the UE's declared maximum aggregated bandwidth. The sum of the bandwidths multiplied by the layers should be less than or equal to the declared maximum bandwidth multiplied by layers capability of the UE. The first baseband processing capacity configuration 300 may be configured with one carrier 302 having 25 MHz multiplied by 4 layers, a second carrier 304 having 50 MHz multiplied by 2 layers, and a third carrier 306 having 100 MHz multiplied by 2 layers which sums to 400 MHz-layers.

FIG. 4 depicts a second example of a carrier aggregation and MIMO configuration based on the reported UE baseband processing capacity of channel bandwidth multiplied by layers suitable for use in implementations of the present disclosure, in accordance with aspects herein. In the second baseband processing capacity configuration 400 the UE supports 400 MHz maximum layers multiplied by the bandwidth. The first carrier 402 may having 25 MHz multiplied by 4 layers, a second carrier 404 with 50 MHz multiplied by 2 layers, and a third carrier 406 with 200 MHz multiplied by 1 layer which sums to 400 MHz-layers.

FIG. 5 depicts a third example of a carrier aggregation and MIMO configuration based on the reported UE baseband processing capacity of channel bandwidth multiplied by layers suitable for use in implementations of the present disclosure, in accordance with aspects herein. In the third baseband processing capacity configuration 500 the UE supports 400 MHz maximum layers multiplied by the bandwidth. The first carrier 502 supports 400 MHz and is multiplied by 1 layer which sums to 400 MHz-layers.

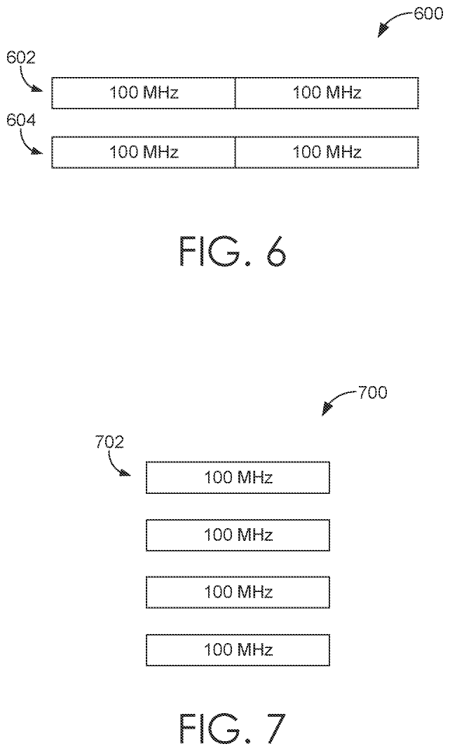

FIG. 6 depicts a fourth example of a carrier aggregation and MIMO configuration based on the reported UE baseband processing capacity of channel bandwidth multiplied by layers suitable for use in implementations of the present disclosure, in accordance with aspects herein. In the fourth baseband processing capacity configuration 600 the UE supports 400 MHz maximum layers multiplied by the bandwidth. There is one carrier with a first layer 602 and second layer 604 supporting 200 MHz multiplied by 2 which sums to 400 MHz-layers.

FIG. 7 depicts a fifth example of a carrier aggregation and MIMO configuration based on the reported UE baseband processing capacity of channel bandwidth multiplied by layers suitable for use in implementations of the present disclosure, in accordance with aspects herein. In the fifth baseband processing capacity configuration 700 the UE supports 400 MHz maximum layers multiplied by the bandwidth. The carrier 702 has 100 MHz multiplied by 4 layers which sums to 400 MHz-layers.

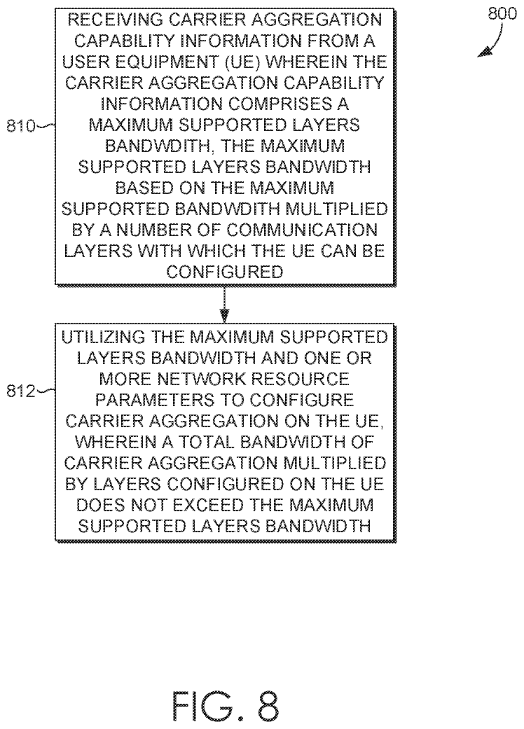

FIG. 8, is a flow diagram for a method for utilizing channel bandwidth and communication layers to indicate baseband processing capacity, in accordance with aspects herein. The method 800 begins in step 810 with receiving carrier aggregation capability information from a UE, wherein the carrier aggregation capability information from a UE, wherein the carrier aggregation capability information comprises a maximum supported layers bandwidth, the maximum supported layers bandwidth based on the maximum supported bandwidth multiplied by a number of communication layers with which the UE can be configured. The method then proceeds with step 812 with utilizing the maximum supported layers bandwidth and one or more network resource parameters to configured carrier aggregation on the UE, wherein a total bandwidth of carrier aggregation multiplied by layers configured on the UE does not exceed the maximum supported layers bandwidth.

The carrier aggregation capability information received from the UE by the access point may comprise at least one of the UE supported maximum aggregated bandwidth multiplied by layers. In addition the carrier aggregation capability information received from the UE may comprise supported bandwidth per band, a maximum bandwidth per band, supported band combination, supported bandwidth combination sets per band combination, or a maximum bandwidth per band in each of the supported band combinations. The carrier aggregation capability information may correspond to uplink or downlink communications and the communication layers may be MIMO layers. The network resource parameters may comprise SINR, how busy a carrier is, or the availability of frequency bands.

Based on the carrier aggregation capability information the UE may be assigned less bandwidth than the UE is capable of processing on each communication layer. In addition, the UE may be assigned both a primary band and a secondary band. The carrier aggregation may also assign the UE a primary cell for use when traffic to or from the UE is lower than a threshold. A second cell may also be assigned to the UE for use with the primary cell when traffic to or from the UE is higher than the threshold. In addition, the primary cell may be used alone without carrier aggregation, or both the primary cell and the secondary cell may be used together with carrier aggregation.

Referring to FIG. 9, a diagram is depicted of an exemplary computing environment suitable for use in implementations of the present disclosure. In particular, the exemplary computer environment is shown and designated generally as computing device 900. Computing device 900 is but one example of a suitable computing environment and is not intended to suggest any limitation as to the scope of use or functionality of the embodiments described herein. Neither should computing device 900 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 9, computing device 900 includes bus 910 that directly or indirectly couples the following devices: memory 912, one or more processors 914, one or more presentation components 916, input/output (I/O) ports 918, I/O components 920, power supply 922, and radio 924. Bus 910 represents what may be one or more busses (such as an address bus, data bus, or combination thereof). The devices of FIG. 9 are shown with lines for the sake of clarity. However, it should be understood that the functions performed by one or more components of the computing device 900 may be combined or distributed amongst the various components. For example, a presentation component such as a display device may be one of I/O components 920. Also, processors, such as one or more processors 914, have memory. The present disclosure hereof recognizes that such is the nature of the art, and reiterates that FIG. 9 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.” In some embodiments, the carrier aggregation relationship configuration logic (CA-RCL) as described in any of the examples of this disclosure may be implemented at least in part by code executed by the one or more processors(s) 914 and in some embodiments.

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes non-transient RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer-storage media in the form of volatile and/or nonvolatile memory. Memory 912 may be removable, nonremovable, or a combination thereof. Exemplary memory includes solid-state memory, hard drives, optical-disc drives, etc. Computing device 900 includes one or more processors 914 that read data from various entities such as bus 910, memory 912 or I/O components 920. One or more presentation components 916 may present data indications to a person or other device. Exemplary one or more presentation components 916 include a display device, speaker, printing component, vibrating component, etc. I/O ports 918 allow computing device 900 to be logically coupled to other devices including I/O components 920, some of which may be built in computing device 900. Illustrative I/O components 920 include a microphone, joystick, game pad, satellite dish, scanner, printer, wireless device, etc.

Radio(s) 924 represents a radio that facilitates communication with a wireless telecommunications network. Illustrative wireless telecommunications technologies include CDMA, GPRS, TDMA, GSM, and the like. Radio 924 might additionally or alternatively facilitate other types of wireless communications including Wi-Fi, WiMAX, LTE, or other VoIP communications. As can be appreciated, in various embodiments, radio(s) 924 can be configured to support multiple technologies and/or multiple radios can be utilized to support multiple technologies. A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

As used herein, the term “computer readable media” refers to tangible memory storage devices having non-transient physical forms. Such non-transient physical forms may include computer memory devices, such as but not limited to: punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system of device having a physical, tangible form. Program instructions include, but are not limited to, computer executable instructions executed by computer system processors and hardware description languages such as Very High Speed Integrated Circuit (VHSIC) Hardware Description Language (VHDL).

As used herein, terms such as base station, radio access network, network operator core, user equipment (UE), baseband unit (BBU), radio unit (RU), scheduler, network node, server, and other terms derived from these words refer to the names of elements that would be understood by one skilled in the art of wireless telecommunications and related industries as conveying structural elements, and are not used herein as nonce words or nonce terms for the purpose of invoking 35 U.S.C. 112(f). The terms “function”, “unit”, “node” and “module” may also be used to describe computer processing components and/or one or more computer executable services being executed on one or more computer processing components.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for utilizing channel bandwidth and communication layers to indicate baseband processing capacity, the method comprising:
receiving carrier aggregation capability information from a user equipment (UE), wherein the carrier aggregation capability information comprises a maximum supported layers bandwidth, the maximum supported layers bandwidth based on the maximum supported bandwidth multiplied by a number of communication layers with which the UE can be configured; and
utilizing the maximum supported layers bandwidth and one or more network resource parameters to configure carrier aggregation on the UE, wherein a total bandwidth of carrier aggregation multiplied by layers configured on the UE does not exceed the maximum supported layers bandwidth.

2. The method of claim 1, wherein the carrier aggregation capability information received from the UE comprises at least one of UE supported maximum aggregated bandwidth multiplied by layers, supported bandwidths per band, a maximum bandwidth per band, supported band combinations, supported bandwidth combination sets per band combination, or a maximum bandwidth per band in each of the supported band combinations.

3. The method of claim 1, wherein the carrier aggregation capability information corresponds to downlink communications.

4. The method of claim 1, wherein the carrier aggregation capability information corresponds to uplink communications.

5. The method of claim 1, wherein the one or more network resource parameters comprise signal to interference and noise ratio (SINR), how busy a carrier is, or availability of frequency bands.

6. The method of claim 1, wherein the communication layers are multiple-input and multiple-output (MIMO) layers.

7. The method of claim 1, wherein configuring the carrier aggregation on the UE further comprises assigning for processing to the UE less bandwidth than the UE is capable of processing on each communication layer.

8. The method of claim 1, wherein configuring the carrier aggregation further comprises assigning a primary band and a secondary band to the UE.

9. The method of claim 1, wherein configuring the carrier aggregation further comprises assigning a primary cell to the UE for use when traffic to or from the UE is lower than a threshold, and a second cell to the UE for use with the primary cell when traffic to or from the UE is higher than the threshold.

10. The method of claim 8, wherein the primary cell is used alone without carrier aggregation.

11. The method of claim 8, wherein the primary cell and the secondary cell are used together with carrier aggregation.

12. A method for utilizing channel bandwidth and communication layers to indicate baseband processing capacity, the method comprising:
transmitting, by a UE, carrier aggregation capability information to an access point, wherein the carrier aggregation capability information comprises a maximum supported aggregated bandwidth multiplied by layers; and
receiving, by the UE, instructions to configure carrier aggregation on the UE, wherein the total bandwidth of carrier aggregation multiplied by layers does not exceed the maximum supported layers bandwidth and is based on a maximum supported aggregated layers bandwidth reported as UE capabilities.

13. The method of claim 12, wherein the carrier aggregation capability information transmitted by the UE comprises at least one of UE supported maximum aggregated bandwidth multiplied by layers, supported bandwidths per band, a maximum bandwidth per band, supported band combinations, supported bandwidth combination sets per band combination, or a maximum bandwidth per band in each of the supported band combinations.

14. The method of claim 12, wherein the carrier aggregation capability information corresponds to downlink communications.

15. The method of claim 12, wherein the carrier aggregation capability information corresponds to uplink communications.

16. The method of claim 12, wherein the communication layers a multiple-input multiple-output (MIMO) layers.

17. The method of claim 12, wherein configuring the carrier aggregation of the UE further comprises assigning less bandwidth multiplied by layers to the UE than the UE is capable of processing.

18. A computer-readable storage media having computer-executable instructions embodied thereon that, when executed by one or more processors, cause the one or more processors to:
receive carrier aggregation capability information from a user equipment (UE), wherein the carrier aggregation capability information comprises a maximum supported layers bandwidth, the maximum supported layers bandwidth based on the maximum supported bandwidth multiplied by a number of communication layers with which the UE can be configured; and
utilize the maximum supported layers bandwidth and one or more network resource parameters to configure carrier aggregation on the UE, wherein a total bandwidth of carrier aggregation multiplied by MIMO layers configured on the UE does not exceed the maximum supported layers bandwidth.

19. The computer-readable storage media of claim 18, wherein configure the carrier aggregation further comprises assigning a primary band and a secondary band to the UE.

20. The computer-readable storage media of claim 18, wherein configure the carrier aggregation further comprises assign a primary cell to the UE for use when traffic to or from the UE is lower than a threshold, and a second cell to the UE for use with the primary cell when traffic to or from the UE is higher than the threshold.
